(19) United States
(12) Patent Application Publication
(10) Pub. No.: US 2012/0026106 A1
(43) Pub. Date: Feb. 2, 2012

(54) ELECTRONIC PAPER DISPLAY

(75) Inventors: Teng-Yi CHIU, TAIPEI HSIEN (TW); Wen-Chin WU, TAIPEI HSIEN (TW); Chuan-Cheng FU, TAIPEI HSIEN (TW); Pei-Chen CHIN, TAIPEI HSIEN (TW); Shih-Yu WANG, TAIPEI HSIEN (TW)

(73) Assignee: WISTRON CORP., TAIPEI HSIEN (TW)

(21) Appl. No.: 13/009,865

(22) Filed: Jan. 20, 2011

(30) Foreign Application Priority Data
Jul. 30, 2010 (TW) 099125442

(51) Int. Cl. G06F 3/041; G09G 3/32

(52) U.S. Cl. 345/173; 345/82

(57) ABSTRACT

Disclosed herein is an electronic paper display. The electronic paper display includes an electronic paper panel, a light guide structure, and a light source. The light guide structure is disposed over the electronic paper panel for reflecting and scattering light. The light source that is disposed on one lateral side of the light guide structure is operable to generate light, wherein the light generated by the light source, after being reflected and scattered by the light guide, illuminates the electronic paper panel.

### RELATED APPLICATIONS

This application claims priority to Taiwan Application Serial Number 99125442, filed Jul. 30, 2010, which is herein incorporated by reference.

### BACKGROUND

1. Field of Invention

The present invention relates generally to a display panel and, more particularly, to an electronic paper panel.

2. Description of Related Art

With advances in electronic technology, various electronic products, such as computers, televisions, mobile phones, etc., have been introduced into the market to meet the consumers' daily demands. E-readers have recently been developed to help meet user demands, as well as in response to the awareness of environmental protection.

Conventional e-readers rely on environmental light sources, such as natural light, lamp-light, etc., to illuminate the electronic paper of the e-readers so that the users may see the contents displayed thereon. In the case where the environmental light sources are insufficient to illuminate the electronic paper (for example, when the user is sitting in a bus at night or a dim outdoor space), users cannot read the contents on the e-readers.

In sum, due to the nature of conventional electronic paper, conventional e-readers must rely on the environmental light sources to display the contents of the e-readers. As such, users cannot utilize the e-readers when the environmental lights are insufficient, and this can cause inconveniences to the users. Accordingly, there exists an urgent need in the related art to provide a solution to address this disadvantage.

### SUMMARY

The following presents a simplified summary of the disclosure in order to provide a basic understanding to the reader. This summary is not an extensive overview of the disclosure and it does not identify key/critical elements of the present invention or delineate the scope of the present invention. Its sole purpose is to present some concepts disclosed herein in a simplified form as a prelude to the more detailed description that is presented later.

An electronic paper display is provided to address or alleviate the conventional problems described hereinabove. Specifically, the electronic paper display provided herein may display the contents therein under dim light or in the absence of environmental light.

To this end, in one aspect, the present invention is directed to an electronic paper display comprising an electronic paper panel, a light-guiding structure, and a light source. The light-guiding structure is disposed above the electronic paper panel, and the light source is disposed on one lateral side of the light-guiding structure. The light-guiding structure is configured to reflect and scatter the light provided by the light source. And the light, after being reflected and scattered by the light-guiding structure, may illuminate the electronic paper panel.

In another aspect, the present invention is directed to an electronic paper display comprising an electronic paper panel and an organic light-emitting diode layer disposed above the electronic paper panel. The organic light-emitting diode layer is an active light source that provides light for the electronic paper panel.

In view of the foregoing, some embodiments of the present invention provide an electronic paper display having a light source and a light-guiding structure so that the light provided by the light source may be reflected and scattered by the light-guiding structure and then illuminate the electronic paper panel. Alternatively, some embodiments of the present invention provide an electronic paper display having an organic light-emitting diode layer as an active light source so that the light provided by the organic light-emitting diode layer illuminates the electronic paper panel. As such, users may read the contents of the e-readers using the electronic paper display according to embodiments of the present invention, even under dim light or in the absence of environmental light.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a schematic diagram illustrating an electronic paper display according to the first embodiment of the present invention;

FIG. 2 is a schematic diagram illustrating an electronic paper display according to the second embodiment of the present invention;

FIG. 3 is a schematic diagram illustrating an electronic paper display according to the third embodiment of the present invention;

FIG. 4 is a schematic diagram illustrating an electronic paper display according to the forth embodiment of the present invention;

FIG. 5 is a schematic diagram illustrating an electronic paper display icy according to the fifth embodiment of the present invention;

FIG. 6 is a schematic diagram illustrating an electronic paper display according to the sixth embodiment of the present invention;

FIG. 7 is a schematic diagram illustrating an electronic paper display according to the seventh embodiment of the present invention; and

FIG. 8 is a schematic diagram illustrating an electronic paper display according to the eighth embodiment of the present invention.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. The use of examples anywhere in this specification, including examples of any terms discussed herein, is illustrative only, and in no way limits the scope and meaning of the disclosure or of any exemplified term. Likewise, the disclosure is not limited to various embodiments given in this specification.

As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise.

As used herein, the terms “comprising,” “including,” “having,” “containing,” “involving,” and the like are to be understood to be open-ended, i.e., to mean including but not limited to.

Electronic paper panels, which are commonly employed in conventional e-readers, are reflective panels. Accordingly, such e-readers rely on environmental light sources, and users cannot read/view the contents when the e-readers are in dim light conditions or present in the absence of environmental light.

Since users may still need to use the e-readers in the absence of environmental light, conventional e-readers are, at times, provided with lateral light sources to illuminate the electronic paper panel. However, by using only the conventional lateral light sources, the e-readers may suffer from uneven distribution of light across the electronic paper panel. Further, more light-emitting diodes may be required due to the unevenness of light, and it in turns causes more power consumption. In view of the foregoing, providing only the lateral light sources in the electronic paper panel would result in the rise of the manufacturing cost and power consumption but still be unable to provide satisfactory reading conditions for the users.

Therefore, electronic paper displays according to embodiments of the present invention are provided here to address or alleviate the problems faced by the conventional electronic paper display.

In one aspect, the present invention is directed to an electronic paper display comprising an electronic paper panel, a light-guiding structure, and a light source. The light-guiding structure is disposed above the electronic paper panel, and the light source is disposed on one lateral side of the light-guiding structure. The light-guiding structure is configured to reflect and scatter the light provided by the light source. And the light, after being reflected and scattered by the light-guiding structure, may illuminate the electronic paper panel. As such, the electronic paper display according to this aspect may display the contents therein under dim light or in the absence of environmental light. Some exemplary embodiments of such electronic paper display are discussed herein below.

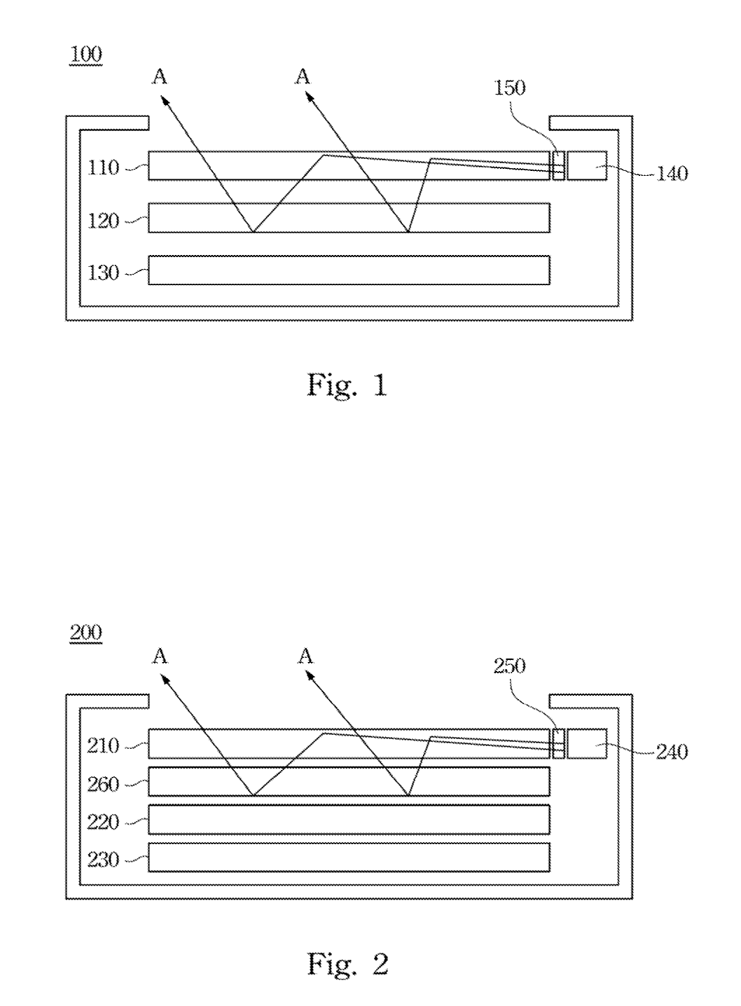

Reference is now made to FIG. 1 which is a schematic diagram illustrating an electronic paper display 100 according to the first embodiment of the present invention. As shown in the figure, the electronic paper display 100 includes a light-guiding structure 110, an electronic paper panel 120, a system 130, a light source 140 and a diffusion sheet 150.

The light-guiding structure 110 is disposed above the upper surface of the electronic paper panel 120. As sued herein, the upper surface of any sheets/layers described herein is referred to as the surface that faces the user during use, whereas a lower surface is the one opposite to the upper surface. Also, each sheet/layer may have at least one lateral side in addition to the upper and lower surfaces.

The light source 140 is disposed on one lateral side of the light-guiding structure 110, and the diffusion sheet 150 is disposed between the light source 140 and the light-guiding structure 110. The light source 140 is operable to irradiate light, and the diffusion sheet 150 is configured to diffuse the light from the light source 140 so as to provide a more uniform light for the light-guiding structure 110. The light-guiding structure 110 is arranged in such a way to receive the diffused light from the diffusion sheet 150 and is operable to reflect and scatter the incident light so that the light may illuminate the electronic paper panel 120. The path of the light in the electronic paper display is shown as arrow A in FIG. 1 to FIG. 8.

According to the principles and spirit of the present invention, the upper surface of the light-guiding structure 110 is treated so that it may exhibit the reflecting and scattering functionalities. For example, the upper surface may be printed with reflective inks, etched with chemicals or lasers, or molded to form structures or microstructures, thereby providing the light-guiding structure 110 with the optical characteristics of a light guide plate. As such, the light-guiding structure 110 provided herein is operable to reflect and scatter the light irradiated by the light source 140 so that the light may illuminate the electronic paper panel 120.

In the embodiments of the present invention, the electronic paper panel 120 may be any reflective panel suitable for use in the e-readers. Illustrative examples of the electronic paper panel 120 include, but are not limited to, electrophoretic display panels and cholesterol liquid crystal display panels.

Generally, the system 130 may include at least one driving circuits, such as the driving circuit(s) for the electronic paper panel 120 and the driving circuit(s) for the light source 140.

As can be appreciated by those with ordinary skill in the art, the light source 140 may include a device for irradiating light, and the device is electrically connected to a power supply. Illustrative examples of the device for irradiating light include, but are not limited to, a cathode fluorescent lamp (“CCFL”), an external electrode fluorescent lamp (“EEFL”), and a light emitting diode (“LED”).

Illustrative materials suitable for use as the diffusion sheet 150 are acrylic resins with a variety of diffusive particles, such as titanium dioxide, silicon dioxide, and silicon.

FIG. 2 is a schematic diagram illustrating an electronic paper display 200 according to the second embodiment of the present invention.

Generally, the electronic paper display 200 includes a light-guiding structure 210, an electronic paper panel 220, a system 230, a light source 240 a diffusion sheet 250, and a touch panel 260. The electronic paper display 200 and the electronic paper display 100 described hereinabove in connection with FIG. 1 are substantially similar in structure, except that the electronic paper display 200 further includes a touch panel 260 which is disposed between the electronic paper panel 220 and the light-guiding structure 210. Accordingly detailed descriptions regarding the arrangements and examples of the elements of electronic paper display 200 are omitted herein for the sake of brevity.

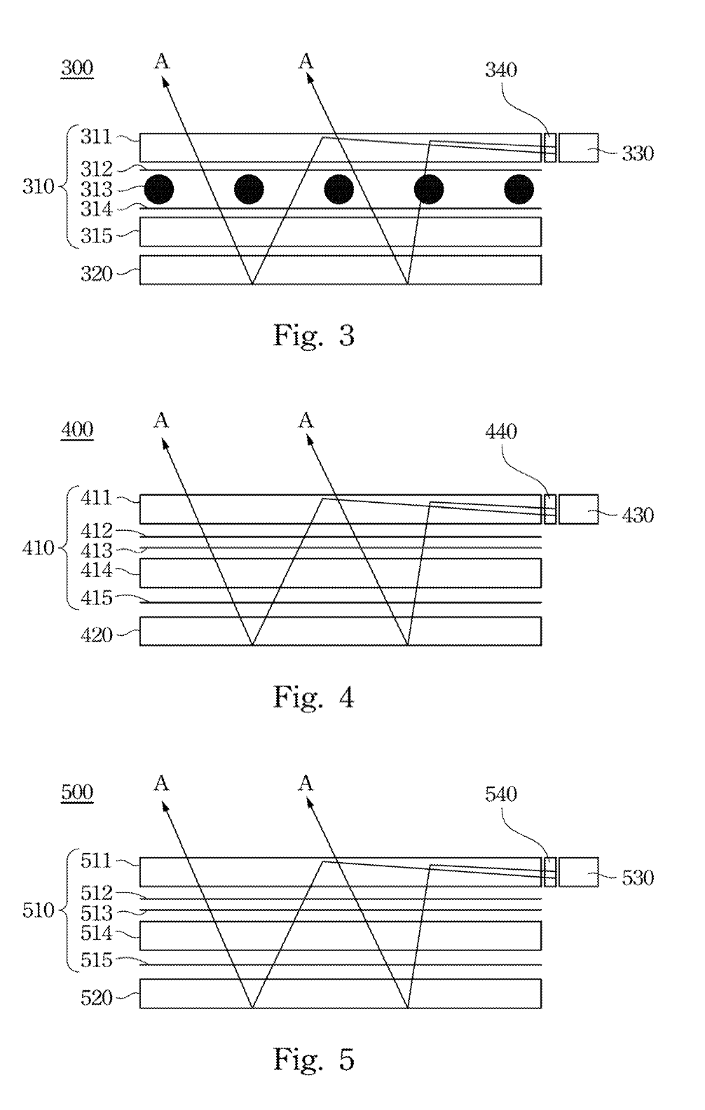

Next, in FIG. 3, a schematic diagram of an electronic paper display 300 according to the third embodiment of the present invention is illustrated.

In this embodiment, the electronic paper display 300 comprises a touch panel 310, an electronic paper panel 320, a light source 330 and a diffusion sheet 340. The electronic paper panel 320, the light source 330 and the diffusion sheet 340 are substantially similar to those described hereinabove in connection with FIG. 1, and hence, detailed descriptions thereof are omitted herein for the sake of brevity and only the structure of the touch panel 310 is further described hereinafter.

AS shown in FIG. 3, the touch panel 310 is disposed above the upper surface of the electronic paper panel 320. According to the principles and spirit of the present invention, the touch panel 310 may be a resistive touch panel and is operable to serve as a light-guiding structure for reflecting and scattering the light toward the electronic paper panel 320.

For example, the touch panel 310 (in this case, a resistive touch panel) may comprise an upper substrate 311, and the light source 330 and diffusion sheet 340 are disposed at one lateral side of the upper substrate 311. The uppermost layer, such as a flexible plastic overlay, of a resistive touch panel may be used as the upper substrate 311 described herein, and the upper surface of the upper substrate 311 may be treated to so that it may exhibit the reflecting and scattering functionalities. For example, the upper surface may be printed with reflective inks, etched with chemicals or lasers, or molded to form structures or microstructures, thereby providing the light-guiding structure 311 with the optical characteristics of a light guide plate. As such, the upper substrate 311 provided herein is operable to reflect and scatter the light diffused by the diffusion sheet 340, thereby illuminating the electronic paper panel 320.

In practice, the touch panel 310 may further comprise an upper indium tin oxide (ITO) layer 312, a plurality of dots 313, a lower ITO layer 314, and a lower substrate 315. The upper ITO layer 312 is disposed on the lower surface of the upper substrate 311, whereas the lower ITO layer 314 is disposed on the upper surface of the lower substrate 315. The layer consisting of dots 313 is sandwiched between the upper ITO layer 312 and the lower ITO layer 314.

For the sake of brevity, a system (such as the system 130 described hereinabove in connection with FIG. 1) of the electronic paper display 300 is not shown in FIG. 3, and it will be clear to those of ordinary skill in the art that, such a system will necessarily be included in the electronic paper display 300.

FIG. 4 is a schematic diagram illustrating an electronic paper display 400 according to the forth embodiment of the present invention.

In this embodiment, the electronic paper display 400 comprises a touch panel 410, an electronic paper panel 420, a light source 430, a diffusion sheet 440, and a system (not shown). The electronic paper panel 420, the light source 430, the diffusion sheet 440, and the system are substantially similar to those described hereinabove in connection with FIG. 1, and hence, detailed descriptions thereof are omitted herein for the sake of brevity and only the structure of the touch panel 410 is further described hereinafter.

As shown in FIG. 4, the touch panel 410 is disposed above the upper surface of the electronic paper panel 420. According to the principles and spirit of the present invention, the touch panel 410 may be a capacitive touch panel and is operable to serve as a light-guiding structure for reflecting and scattering the light toward the electronic paper panel 420.

For example, the touch panel 410 (in this case, a capacitive touch panel) may comprise an upper substrate 411, and the light source 430 and diffusion sheet 440 are disposed at one lateral side of the upper substrate 411. The uppermost layer (such as a sensor glass/flexible print circuit sheet or a cover glass/flexible print circuit sheet) of a capacitive touch panel may be used as the upper substrate 411 described herein, and the upper surface of the upper substrate 411 may be treated to so that it may exhibit the reflecting and scattering functionalities. For example, the upper surface may be printed with reflective inks, etched with chemicals or lasers, or molded to form structures or microstructures, thereby providing the light-guiding structure 411 with the optical characteristics of a light guide plate. As such, the upper substrate 411 provided herein is operable to reflect and scatter the light diffused by the diffusion sheet 440, thereby illuminating the electronic paper panel 420.

In practice, the touch panel 410 may further comprise an upper ITO layer 412, a pressure sensitive adhesive (PSA) layer 413, a lower substrate 414, and a lower ITO layer 415. The upper ITO layer 412 is disposed on the lower surface of the upper substrate 411, whereas the lower ITO layer 415 is disposed on the lower surface of the lower substrate 414. The PSA layer 413 is sandwiched between and bonds together the upper ITO layer 412 and the lower substrate 414.

FIG. 5 is a schematic diagram illustrating an electronic paper display 500 according to the fifth embodiment of the present invention.

In this embodiment, the electronic paper display 500 comprises a touch panel 510, an electronic paper panel 520, a light source 530, a diffusion sheet 540, and a system (not shown). The electronic paper panel 520, the light source 530, the diffusion sheet 540, and the system are substantially similar to those described hereinabove in connection with FIG. 1, and hence, detailed descriptions thereof are omitted herein for the sake of brevity and only the structure of the touch panel 510 is further described hereinafter.

AS shown in FIG. 5, the touch panel 510 is disposed above the upper surface of the electronic paper panel 520. According to the principles and spirit of the present invention, the touch panel 510 may be a capacitive touch panel and is operable to serve as a light-guiding structure for reflecting and scattering the light toward the electronic paper panel 520.

For example, the touch panel 510 (in this case, a capacitive touch panel) may comprise an upper substrate 511, and the light source 530 and diffusion sheet 540 are disposed at one lateral side of the upper substrate 511. The uppermost layer (such as a protector sheet) of a capacitive touch panel may be used as the upper substrate 511 described herein, and the upper surface of the upper substrate 511 may be treated to so that it may exhibit the reflecting and scattering functionalities. For example, the upper surface may be printed with reflective inks, etched with chemicals or lasers, or molded to form structures or microstructures, thereby providing the light-guiding structure 511 with the optical characteristics of a light guide plate. As such, the upper substrate 511 provided herein is operable to reflect and scatter the light diffused by the diffusion sheet 540, thereby illuminating the electronic paper panel 520.

In practice, the touch panel 510 may further comprise a PSA layer 512, an upper ITO layer 513, a lower substrate 514, and a lower ITO layer 515. The upper ITO layer 513 is disposed on the upper surface of the lower substrate 514, whereas the lower ITO layer 515 is disposed on the lower surface of the lower substrate 514. The PSA layer 512 bonds the upper ITO layer 513 to the lower surface of the upper substrate 511.

In another aspect, the present invention is directed to an electronic paper display comprising an electronic paper panel and an organic light-emitting diode layer disposed above the electronic paper panel. The organic light-emitting diode layer is an active light source that provides light for the electronic paper panel. As such, the electronic paper display provided herein may display the contents therein under dim light or in the absence of environmental light. Some exemplary embodiments of such electronic paper display are discussed herein below.

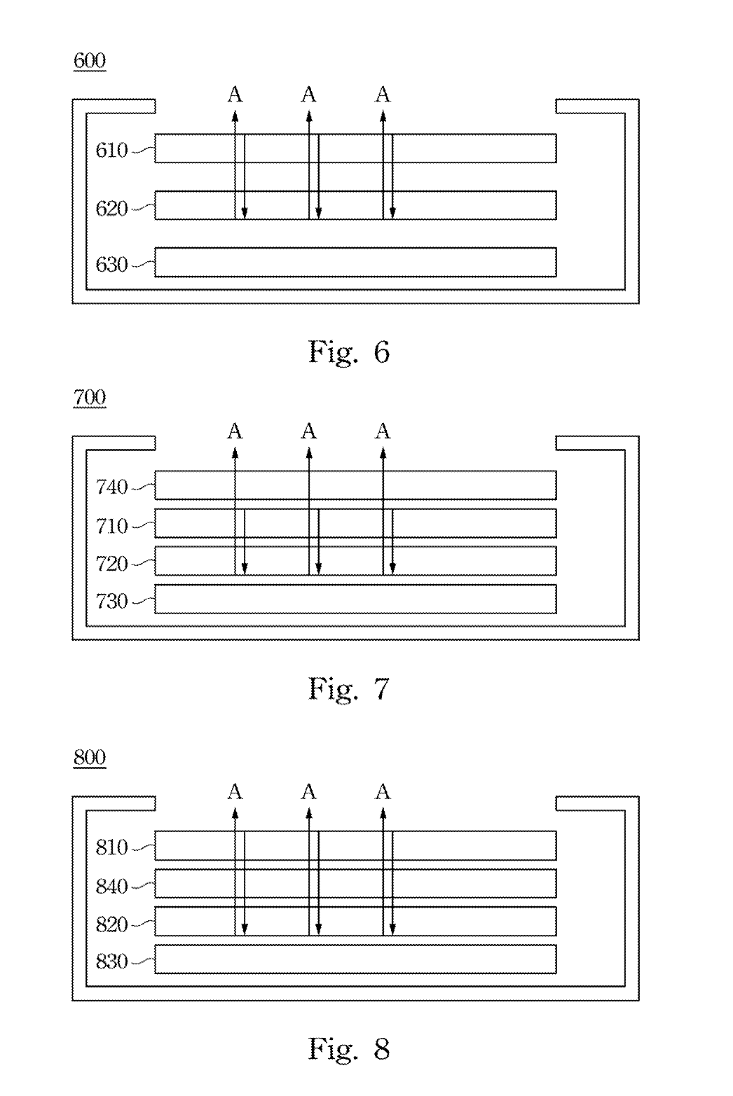

Reference is now made to FIG. 6 which is a schematic diagram illustrating an electronic paper display 600 according to the sixth embodiment of the present invention. As shown in the figure, the electronic paper display 600 comprises an organic light-emitting diode layer 610, an electronic paper panel 620 and a system 630.

The organic light-emitting diode layer 610 is disposed above the electronic paper panel 620. According to the principles and spirit of the present invention, the organic light-emitting diode layer 610 serves as an active light source for irradiating light that illuminate the electronic paper panel 620.

The electronic paper panel 620 is substantially similar to those described hereinabove in connection with FIG. 1, and hence, detailed descriptions thereof are omitted herein for the sake of brevity.

Similar to system 130 described hereinabove, the system 630 of this embodiment may also comprise at least one driving circuit. Illustrative examples of the driving circuits include, but are not limited to, driving circuit(s) for the electronic paper panel 620 and the driving circuit(s) for the organic light-emitting diode 610.

As discussed hereinabove, the organic light-emitting diode layer 610 is an active-matrix organic light-emitting diode layer. As is appreciated by those of ordinary skill in the art, it is possible to switch on/off the individual pixel of the active-matrix organic light-emitting diode layer 610 so that only a portion of the electronic paper panel 620 is illuminated while the other portion(s) may not be illuminated.

Is FIG. 7 is a schematic diagram illustrating an electronic paper display 700 according to the seventh embodiment of the present invention.

Generally, electronic paper display 700 comprises an organic light-emitting diode layer 710, an electronic paper panel 720, a system 730, and a touch panel 740. The electronic paper display 700 and the electronic paper display 600 described hereinabove in connection with FIG. 6 are substantially similar in structure, except that the electronic paper display 700 further comprises the touch panel 740. Accordingly detailed descriptions regarding the arrangements and examples of the elements of electronic paper display 700 are omitted herein for the sake of brevity.

As shown in FIG. 7, the touch panel 740 is disposed on the upper surface of the organic light-emitting diode layer 710. Illustrative examples of the touch panel 740 include, but are not limited to, resistive touch panels and capacitive touch panels.

FIG. 8 is a schematic diagram illustrating an electronic paper display 800 according to the eighth embodiment of the present invention.

Generally, electronic paper display 800 comprises an organic light-emitting diode layer 810, an electronic paper panel 820, a system 830, and a touch panel 840. The electronic paper display 800 and the electronic paper display 700 described hereinabove in connection with FIG. 7 are substantially similar in structure, except that the touch panel 840 of the electronic paper display 800 is disposed between the electronic paper panel 820 and the organic light-emitting diode layer 810. Accordingly detailed descriptions regarding the arrangements and examples of the elements of electronic paper display 800 are omitted herein for the sake of brevity.

In view of the foregoing detailed description, many advantages of the present invention are now apparent. Some of the advantages are discussed as follows, whereas other advantages of the present invention will be apparent to those of ordinary skill in the art in view of the specification, claims and drawings provided herein.

According to some embodiments of the present invention, electronic paper displays are provided with a light source and a light-guiding structure such that the light irradiated by the light source is reflected and scattered by the light-guiding structure and then illuminates the electronic paper panel. Alternatively, in some embodiments of the present invention, electronic paper displays are provided with an organic light-emitting diode layer serving as an active light source so as to illuminate the electronic paper panel. As such, users may view the contents of the e-readers by using the electronic paper display according to embodiments of the present invention, even under dim light or in the absence of environmental light.

As compared with conventional electronic paper displays that employ only a light source, the electronic paper displays according to some embodiments of the present invention provide better quality content by providing the electronic paper displays with a light source and a light-guiding structure such that the light can be evenly distributed across the electronic paper panel. Hence, the present electronic paper displays may provide users with a more satisfactory reading experience.

Similarly, the electronic paper displays according to some embodiments of the present invention are provided with an organic light-emitting diode layer as an active light source that may irradiate a more uniform light as compared with other light sources. As such, the present electronic paper displays provide better quality content which results in a more satisfactory reading experience.

Moreover, due to the more uniform distribution of light, it is possible to reduce the amount of the devices for irradiating light (such as light-emitting diodes). In addition, the pixels of the active-matrix organic light-emitting diode can be individually switched on or off so that only a portion of the active-matrix organic light-emitting diode layer irradiates light. In both instances, the power consumption of the electronic paper displays may be reduced.

Further, with respect to the electronic paper displays comprising a touch panel and a light-guiding structure, the light-guiding structure may optionally be formed on the upper substrate of the touch panel. As compared with providing an additional light-guiding element, integrating the light-guiding structure in the upper substrate of the touch panel may lower the manufacturing cost, reduce the overall thickness of the final product, and increase the light transmittance. In addition, the process for forming the light-guiding structure on the upper substrate is simple and compatible with existing manufacturing process.

It will be understood that the above description of embodiments is given by way of example only and that various modifications may be made by those with ordinary skill in the art. The above specification, examples and data provide a complete description of the structure and use of exemplary embodiments of the invention. Although various embodiments of the invention have been described above with a certain degree of particularity, or with reference to one or more individual embodiments, those with ordinary skill in the art could make numerous alterations to the disclosed embodiments without departing from the spirit or scope of this invention, and the scope thereof is determined by the claims that follow.

What is claimed is:

1. An electronic paper display comprising:
an electronic paper panel;
a light-guiding structure disposed above the electronic paper panel, for reflecting and scattering light;
a light source disposed on one lateral side of the light-guiding structure, for providing the light; and
a diffusion sheet disposed between the light source and the light-guiding structure, for diffusing the light generated by the light source to provide the light for the light-guiding structure;
wherein the light generated by the light source, after being reflected and scattered by the light-guiding structure, illuminates the electronic paper panel.

2. The electronic paper display according to claim 1, further comprising:
a touch panel disposed between the electronic paper panel and the light-guiding structure.

3. The electronic paper display according to claim 1, wherein the light-guiding structure is a touch panel.

4. The electronic paper display according to claim 3, wherein the touch panel comprises:
an upper substrate, wherein the light source is disposed on one lateral side of the upper substrate, and the upper substrate is provided for reflecting and scattering the light such that the light illuminates the electronic paper panel.

5. An electronic paper display comprising:
an electronic paper panel; and
an organic light-emitting diode layer, used as an active light source, disposed over the electronic paper panel for generating light to illuminate the electronic paper panel.

6. The electronic paper display according to claim 5, further comprising:
a touch panel disposed between the electronic paper panel and the organic light-emitting diode layer.

7. The electronic paper display according to claim 5, further comprising:
a touch panel disposed over the organic light-emitting diode layer.
